(19) United States
(12) Patent Application Publication
(10) Pub. No.: US 2015/0178647 A1
(43) Pub. Date: Jun. 25, 2015

(54) METHOD AND SYSTEM FOR PROJECT RISK IDENTIFICATION AND ASSESSMENT

(71) Applicant: Sysenex, Inc., Reston, VA (US)

(72) Inventors: Laurie WIGGINS, Reston, VA (US); David HALL, Toney, AL (US)

(21) Appl. No.: 14/630,328

(22) Filed: Feb. 24, 2015

Related U.S. Application Data
(63) Continuation-in-part of application No. 13/936,809, filed on Jul. 8, 2013.
(60) Provisional application No. 61/669,328, filed on Jul. 9, 2012.

(51) Int. Cl. G06Q 10/06

(52) U.S. Cl. CPC G06Q 10/0635

(57) ABSTRACT

Disclosed herein is a system and method for project risk assessment. The system and method include collecting project identification information, receiving responses to a single comprehensive query about the project, using the responses to find specific characteristics of a coupled module for performing tasks related to the project, and determining a risk level of the module performing the tasks based on the specific characteristics of the coupled module.

### CROSS REFERENCE TO RELATED APPLICATIONS

This application is a continuation-in-part of U.S. patent application Ser. No. 13/936,809, filed Jul. 8, 2013, which is a non-provisional U.S. Provisional Patent Application No. 61/669,328, filed Jul. 9, 2012, the disclosures of which are expressly incorporated herein by reference.

### FIELD

The present system relates to identification of risk before, during and after the creation of hardware and software programs and applications, as well as modifications and updates of same.

### BACKGROUND

Currently, program risk identification is performed manually and suffers from the lack of a repeatable, comprehensive or complete approach. Current methods of risk identification include real-time methods such as brainstorming, drawing upon experience from previous programs via colleagues, subject matter experts, customers or system users, development of failure scenarios, or examination of the program work plan. All of these methods are subject to significant errors and omissions. Further, manual risk identification is subject to bias even by very experienced and knowledgeable personnel. While other program processes have evolved and improved, risk identification methods have not changed in at least fifty years.

The state of the general risk analysis art is shown in various documents. U.S. Pat. No. 8,195,546 (entitled “Methods and systems for risk evaluation”), U.S. Pat. No. 8,135,605 entitled “Application Risk and Control Assessment Tool”), U.S. Pat. No. 8,050,993 (entitled “Semi-quantitative Risk Analysis”), U.S. Patent Application Publication No. 2011/0282710 (entitled “Enterprise Risk Analysis System”), and U.S. Patent Application Publication No. 2010/0205042 (entitled “Integrated Risk Management Process”). These methods disclose risk analysis but are directed toward managing risk in business and/or financial operations.

Current methods of identifying and evaluating risk are manual—they involve brainstorming, experience from previous programs, development of failure scenarios, or examination of a program work plan. U.S. Pat. No. 8,150,717 (entitled “Automated Risk Assessments Using a Contextual Data Model That Correlates Physical and Logical Assets”), U.S. Pat. No. 8,010,398 (entitled “System for Managing Risk”), U.S. Patent Application Publication No. 2011/0137703 (entitled “Method and System for Dynamic Probabilistic Risk Assessment”), and U.S. Patent Application Publication No. 2010/0063936 (entitled “Method and System for Evaluating Risk Mitigation Plan”).

### SUMMARY OF THE INVENTION

Disclosed herein is a method for project and program risk assessment. The method includes the steps of collecting project identification information, receiving responses to a single comprehensive query about the project, using the responses to find specific characteristics of a coupled module for performing tasks related to the project, and determining a risk level of the module performing the tasks based on the specific characteristics of the coupled module.

The single comprehensive survey is based on a set of known factors and is applicable to mutually exclusive projects, i.e., only one survey is necessary for all projects. There is no need to customize the survey to make it specific to a particular project. The set of known factors includes at least two hundred and eighteen mutually exclusive factors. The performed tasks affect at least one of the following risk areas: technical risk, organizational risk, operational risk, management risk, external managerial risk and enterprise risk.

Additionally, a generic risk determination, based on all of the areas, is produced. All of the risk areas collectively include thirty-one risk categories and all of the risk categories collectively include the two hundred and eighteen individual risks. There is no requirement that all of the individual risks be considered; rather, less than all of the individual risks can be considered when determining the risk level. In any case, a risk level is determined for each of the risk areas that are chosen for analysis.

The risk level can be revised in response to a user request, based on revising one of the risk factors. The user can change a factor (complexity), which goes into the scoring of the risk.

The specific characteristics of the coupled module include a history of the coupled module, total bandwidth of the coupled module, available bandwidth of the coupled module, special resources of the coupled module, logistics, quality of resources, reuse of previously used resources, environment, regulatory considerations, geographic concerns and testing results.

Before, during or after the project, the determining step can be performed. Also, a risk trend over time can be plotted during project execution. And the determined risk can be modified based on the risk trend as the risk trend is plotted.

Risks resolved early in a project, program or service development program prevent problems from occurring, thus avoiding the time and money required to fix them. The cost avoidance can be dramatic: the cost of fixing software or hardware problems before the product or service is built can save 300-500 times the cost incurred later in development. Symptoms of costly program problems are present early in development. If recognized, these symptoms can be addressed quickly and easily, and the system assists program personnel to do just that. While this risk system and method can be applied at any point in product or service development or operation, the earlier it is applied in the process, the more time and money can be saved. The risks presented in this system and method are those items that have been demonstrated to create costly and time consuming program problems if they are not addressed. The presently disclosed system and method identifies and evaluates risk. No other currently available tools do so.

A universal set of risks are embodied in the present risk system. For each risk, five (5) levels that assist the User to understand the current level of resolution of the risk. Has the risk been addressed at all? If not, the User would assess the risk at Level 5, the highest level of risk. If the risk has been partially addressed, a level of 2, 3, or 4 is assigned depending on the work already completed. If the risk has been fully addressed, it is assigned a level 1, the lowest level of risk.

Based on answers to questions posed by the system, the system ascertains the level of program complexity. Combined with weighted values derived for each risk, a set of scores is calculated for each individual risk. These risks have been grouped into six risk areas: technical, operational, managerial, organizational, enterprise and external. Scores are calculated for each risk, risk area as well as for the overall program. Report outputs include the list of risks, their risk levels, and scores for each risk, risk area and the program.

Any of the presently disclosed steps can be carried out through appropriate means. For example, a means for creating a software program and for receiving User input is a computer processor. The system and method can be implemented on a standalone server or cloud-based virtual server system accessible via the internet. The presently disclosed system and method can be implemented on laptops, desktop personal computers, mobile devices such as a tablet or mobile phone. Users may also access the system via internal company or organization servers or internal clouds.

### BRIEF DESCRIPTION OF THE DRAWINGS

FIG. 1 is a flowchart showing steps of operation of the disclosed method and system;

FIG. 2 is a risk example showing common mode/cascading failures; and

FIGS. 3a and 3b are excerpts from a trending analysis.

### DETAILED DESCRIPTION

The present system provides an objective, comprehensive approach to risk identification and assessment. It helps Users address program areas and individual risks—any one of which could be overlooked by a manual approach. Each risk is weighted based on statistical frequency of occurrence, as well as the effect upon past programs when the risk occurred.

Program complexity is assessed via multiple choice questions posed to the User by the system, and the system provides a recommended complexity level. The User has the option of overriding this choice and indicating a different complexity level if desired. Complexity is evaluated based on program schedule duration (in an identifiable unit of time or benchmarks) cost (in dollars or resources), days of program effort of all program personnel, number of technologies or disciplines involved, and program influencing factors. Complexity is an important aspect with regards to risk, because the greater the program complexity, the higher the risk level for the program at analysis start.

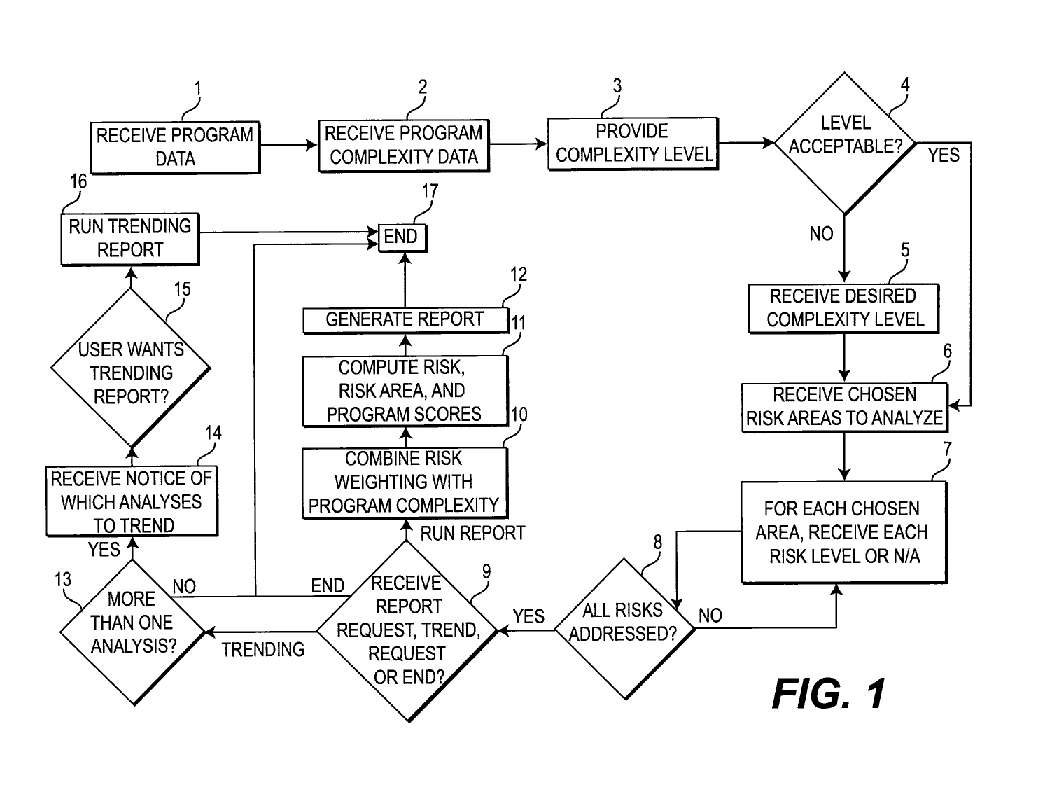

The following steps correlate to those shown in FIG. 1. Once a User activates the risk program, a User inputs program or project data including program name and other particulars. The User is then prompted to answer multiple choice questions posed by the system to ascertain program complexity. Questions include those discussed in the previous paragraph for schedule duration, cost, program effort, technologies/disciplines involved, and influencing factors. The system computes a program complexity based on User answers and provides the complexity level to the User. The User has the option of accepting the system's complexity or overriding it by providing a different level.

The User is then presented with the risk areas and can choose all or any combination of them to analyze. As shown in the tables above, the risk areas include Technical, Operational, Organizational, Managerial, External and Enterprise. For each risk area, risks are grouped by categories. The User evaluates each individual risk by either judging the risk to be “N/A” (Not Applicable to the User's program) or choosing one of five risk levels presented to the User.

The presently disclosed system and method for assessing risk in project, program or service hardware and software development receives user input respecting the software program, and identifying risks. User input includes query functions and data display and reporting capabilities. User input is compared with a stored set of statistically determined risks.

Statistically determined risks are stored in a database and are provided to the User for analysis. There are currently 218 risks as shown below in Tables 1-6, which include all risk areas, categories and individual risks that are used to properly assess project and program risk. However, the nature of program risk evolves over time, so the present system allows for changes to the risks, and additions or deletions, over time. The weighting uses an Analytical Hierarchy Method. Thus, a risk which occurs frequently and has a severe negative effect when it occurs has a high weight. The individual risks are shown below:

TABLE 1

| RISK AREA/CATEGORY | |
|---|---|
| ENTERPRISE RISKS: | RISK TITLE |
| Enterprise Approach | Enterprise Experience |
| | Business/Mission Benefit |
| | Enterprise Culture |
| | Enterprise Interest in Personnel Motivation |
| | Enterprise Reputation |
| | Enterprise Financial Impact |
| Enterprise Processes | Enterprise Management Processes |
| | Enterprise Financial Process |
| | Enterprise Critical Processes |
| | Enterprise Business Process Change |
| Enterprise Security | Overall Enterprise Data Protection |
| | Overall Enterprise System Protection |
| | Enterprise Security Processes |
| Enterprise Risk Approach | Enterprise Lessons Learned Process |
| | Enterprise Contingency Planning |
| | Enterprise Risk Management Process |
| | Common Program Portfolio |

TABLE 2

| RISK AREA/CATEGORY | |
|---|---|
| MANAGEMENT RISKS: | RISK TITLE |
| Management Approach and | Planning |
| Experience | Work Plan or Work Breakdown Structure |
| | Life Cycle Management Method |
| | Achievable Goals |
| | Program Scope |
| | Resources and Commitment |
| | Contingency Planning |
| | Contract Requirements |
| | Management Experience |
| | Coordination |
| | Reviews |
| | Program Manager Span of Control |
| Personnel Approach | Team Organization |
| | Team Size |
| | Overall Program Staffing |
| | Staffing Plan |
| | Personnel Experience |
| | Roles, Responsibilities and Authority |
| | Expected or Current Program Specialized |
| | Personnel Turnover Rate |
| | Current Total Personnel Turnover Rate |
| | Personnel Morale |
| | Management Interest in Personnel |
| | Motivation |
| Funding, Cost and Schedule | Estimating Program Cost and Schedule |
| | Cost Development |
| | Cost Maintenance |
| | Funding Profile |
| | Schedule Development |
| | Schedule Maintenance |
| Management Processes | Management Processes |
| | Mission Assurance Process |
| | Risk Management Process |
| | Risk Management Process Maturity |
| | Management Process Change |
| | Supplier Management |
| | Subcontractor Management |
| | Program Security Processes |
| Measurement and Reporting | Metrics |
| | Measurement |
| | Status Reporting |

TABLE 3

| RISK AREA/CATEGORY | |
|---|---|
| EXTERNAL RISKS: | RISK TITLE |
| Customer Focus | Program Fit to Customer Organization |
| | Current Customer Personnel Turnover rate |
| | Customer Experience |
| | Customer Interaction |
| Funding, Labor, | Funding |
| Regulatory and Legal | Regulatory |
| | Legal |
| | Litigation |
| | Political |
| | Labor Market |
| Threats and the Environment | Destination/and/or Use Environment |
| | Environmental |
| | Country Stability |
| | Direct or Indirect Threats |

TABLE 4

| RISK AREA/CATEGORY | |
|---|---|
| ORGANIZATIONAL RISKS: | RISK TITLE |
| Organizational Approach | Organizational Experience |
| | Organizational Business/Mission Benefit |
| | Organizational Culture |
| | Organizational Interest in Personnel |
| | Motivation |
| | Organizational Risk Management Process |
| | Maturity |
| Organizational Processes and | Lessons Learned |
| Procedures | Organizational Infrastructure |
| | Organizational Management Processes |
| | Organizational Financial Process |
| | Organizational Critical Processes |
| | Organizational Business Process Change |
| | Organizational Risk Management Process |
| Organizational Security | Overall Organizational Data Protection |
| | Overall Organizational System Protection |
| | Organizational Security Processes |

TABLE 5

| RISK AREA/CATEGORY | |
|---|---|
| OPERATIONAL RISKS: | RISK TITLE |
| System Maintenance | Use and Maintenance Complexity |
| | Deployment Locations |
| | System Supportability |
| | Inventory |
| | Available Data and Documentation |
| | Facilities/Sites |
| Security | Direct or Indirect Threats |
| | Operational Security |
| | Program Privacy and Data Protection |
| | Policies |
| | System Data Protection |
| | System Security Testing |
| | System Software Update |
| Operational Processes and | System Operational Problems |
| Personnel | Obsolescence Management Process |
| | Metrics |
| | System Configuration Management |
| | Functional Testing |
| | Disposal |
| | Operational Risk Management Process |
| | Maturity |
| | Personnel Training and Experience |
| | Transportation Complexity |
| | Health and Safety |
| | Operational Personnel |
| Failure Detection and Protection | System Failure Contingencies |
| | Infrastructure Failure |
| | Human Error |
| | System Availability |
| | External Dependencies |
| | Business Data |
| | Common-Mode or Cascading Failures |
| | Near Miss Consideration |
| Operational Readiness | Readiness Verification |
| | Acceptance Criteria |
| | Acceptance Testing |
| Operations Impact on Company | Financial |
| | Profitability |
| User Considerations | User Acceptance |
| | User Satisfaction |

TABLE 6

| RISK AREA/CATEGORY | |
|---|---|
| TECHNICAL RISKS: | RISK TITLE |
| System Definition and | Requirements Definition |
| Integration | Requirements Stability |
| | Requirements Flow down |
| | Project Documentation |
| | Interface Definition and Control |
| | Trade Studies |
| | Metrics |
| | Systems Integration |
| | External Dependencies |
| | System Definition and Validation |
| | Integration Environment and Resources |
| | Common Mode/Cascading Failures |
| Common Technical Risks | Quality |
| | Safety |
| | Facilities/Sites |
| | Logistics Supportability |
| | Productivity |
| | Personnel Training |
| | User Interaction |
| | Customer Interaction |
| System Design | Technology Maturity |
| | Design Maturity |
| | Concurrency |
| | Common Weakness Analysis |
| | Failure Analysis |
| | Models and Simulations |
| | Prototypes |
| | Development and Implementation Support |
| | Resources |
| | Sensitivity of Technology and Design to |
| | Threat |
| | Potential For Operational Failure |
| | Potential For Human Error |
| Software Specific Risks | Data Quality |
| | Data Conversion |
| | Software Complexity (Cyclomatic |
| | Complexity) |
| | Software Development |
| | Software Module Maturity |
| | Software Integration |
| | Software Module Reliability and Quality |
| | Experience Required to Implement Software |
| | Module |
| | Software Development Personnel |
| | Software Data Requirements |
| | Software Integration Maturity |
| Hardware Specific Risks | Hardware Module Reliability and Quality |
| | Experience Required to Implement Hardware |
| | Module |
| | Hardware Development Personnel |
| | Hardware Data Requirements |
| | Hardware Integration Maturity |
| | Hardware Capability |
| | Transportation Complexity |
| Hardware Specific Risks | Hardware Module Reliability and Quality |
| | Experience Required to Implement Hardware |
| | Module |
| | Hardware Development Personnel |
| | Hardware Data Requirements |
| Processes | Critical Processes |
| | Software Methodology and Process Maturity |
| | Hardware Methodology and Process |
| | Maturity |
| | Parts, Material and Processes |
| | Obsolescence Management Process |
| | Software Development Best Practices |
| | Hardware Configuration Management |
| | Software Configuration Management |
| | Change Management Process |
| | Root Cause Analysis Process |
| Production/Fabrication | Manufacturing Readiness |
| | Fabrication Processes |
| | Producibility |
| | Material |
| | Acquisition of Items |
| | Inventory |
| Test | Test Requirements and Objectives |
| | System Test |
| | Component, Unit and Subsystem Testing |
| | Planning |
| | Testing Planning |
| | Component, Unit and Subsystem Testing |
| | Resources |
| | System Testing Resources |
| | Component, Unit and Subsystem Testing |
| | Progress |
| | System Testing Progress |
| | Functional Testing |
| | Testing Required to Establish Functionality |
| | Component or Unit Software Performance |
| | Functionality |
| | Component or Unit Hardware Performance |
| | Functionality |
| | System Software Performance Functionality |
| | System Hardware Performance Functionality |
| | System Performance Functionality |
| Commercial Off the | COTS/GOTS/Reuse Planning |
| Shelf/Government Off the | COTS/GOTS/Reuse Availability |
| Shelf/Reuse | COTS/GOTS/Reuse Experience |
| (COTS/GOTS/Reuse) | COTS/GOTS/Reuse Integration Process |
| | COTS/GOTS/Reuse Use |
| | COTS/GOTS/Reuse Component Maturity |
| | COTS/GOTS/Reuse Supplier Flexibility |
| | Reuse Readiness |
| | COTS/GOTS/Reuse Complexity |
| | COTS/GOTS/Reuse Supplier Product Help |
| | COTS/GOTS/Reuse Documentation and |
| | Training |
| | COTS/GOTS/Reuse Product Volatility |
| | COTS/GOTS/Reuse Component |
| | Applicability |
| | COTS/GOTS/Reuse Component Quality |
| | COTS/GOTS/Reuse Obsolescence |
| | Management Process |

Risks included in the system/method for assessing risk in hardware or software development center on common mode/cascading failures. A common-mode failure potential compromises the independence assumption between different subsystems or diverse software versions. A common-mode failure occurs when two or more components or subsystems fail in exactly the same way and at the same time.

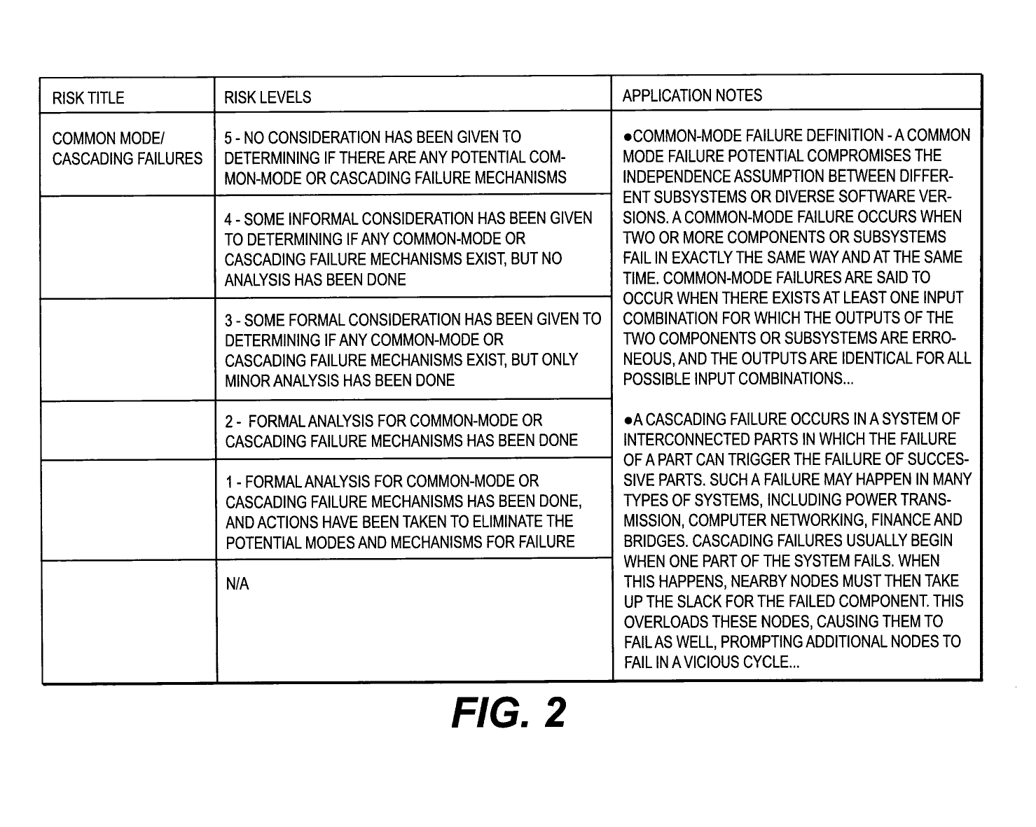

As shown in FIG. 2, a user is provided with five choices for evaluating how well such a risk has been previously addressed with choices such as: “formal analysis . . . has been done . . . and actions have been taken to eliminate the . . . mechanisms for failure” (low risk, Level 1) to: “no consideration has been given to determining . . . potential common-mode or cascading failure mechanisms” (high risk, Level 5).

With reference to FIG. 2, results of one analysis can be compared to another analysis. A program should be analyzed for risks periodically over the program life cycle. In order to assess risk identification mitigation efforts, it is useful to compare the results of earlier and later analyses, known as trending, to assess areas that require attention.

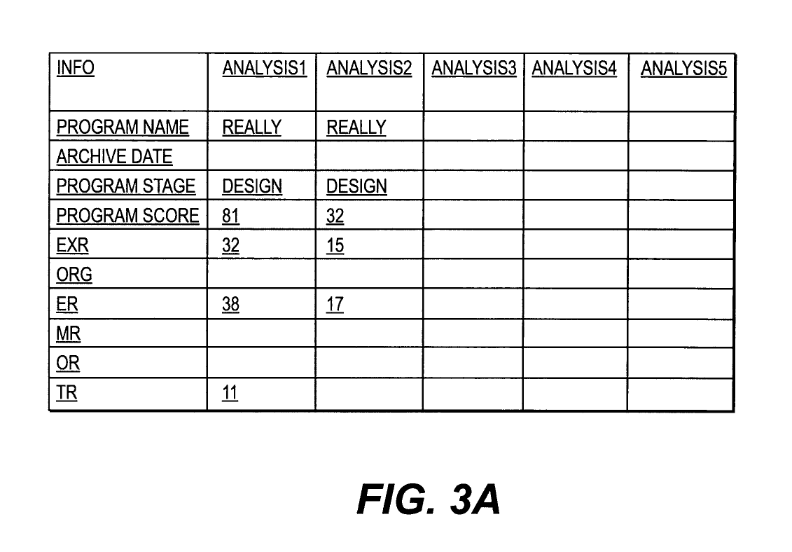

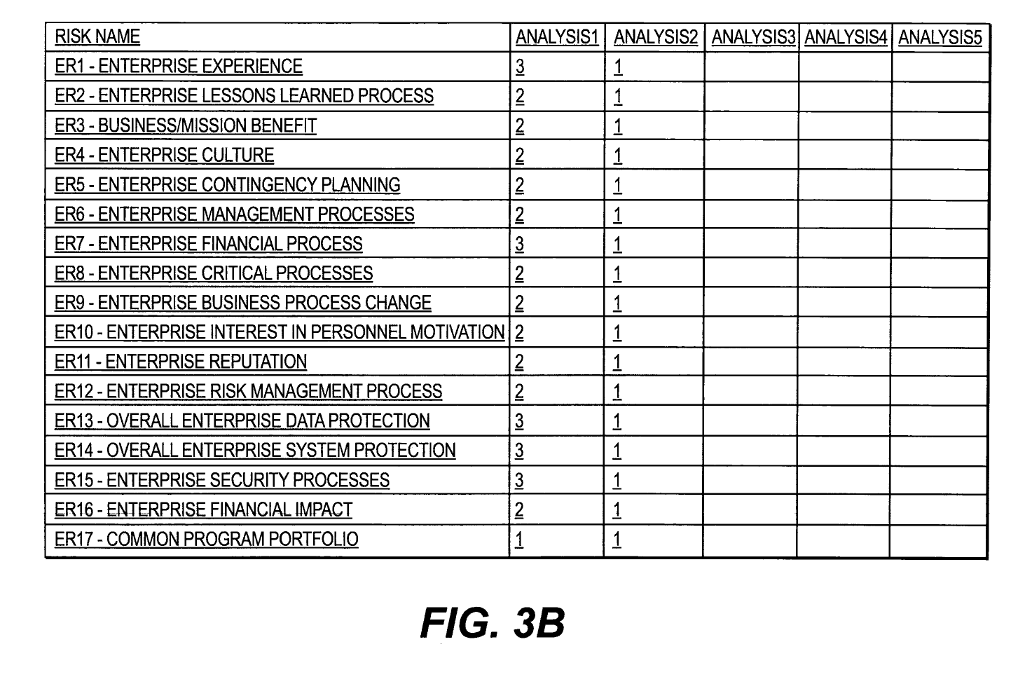

Once all risks are addressed, the User chooses what to do next. The User can run a report, perform a trending analysis, as shown in FIG. 3, if more than one analysis exists for the same program, or end system use. If the User runs a report, the system uses the weighted score associated with each chosen risk level based on the program complexity level. Scores are then computed for each individual risk, risk area and the overall program. The number of risks indicated as N/A (Not Applicable) is tallied and multiplied by an offset factor, then subtracted from the initial program score to achieve the final program score. The User is presented with the score results and can export the report to a variety of formats including Microsoft Word and Excel, PDF and CSV.

Trending is comparing two or more analyses for a given program to understand how the risks are evolving over time. If there are more than two analyses, the User chooses which analyses to trend. The User is presented with the score results for all chosen analyses side-by-side and can export the report to a variety of formats including Microsoft Word and Excel, PDF and CSV.

As shown in FIG. 2, Application notes are provided for most risks to assist the User in understanding the risk and applying it to a specific product or service program. The system can record User notes to aid the User in referencing the analysis results for future reference and analysis.

An enterprise embodiment accommodates many users or teams of users geographically dispersed in simultaneous use. The system has a set of frequently asked questions and answers and accommodates keyword searches. The current set of risks embodied in the system and method can be used as a framework for a company to capture risks specific to a product or service that serve as a historical or lessons-learned archive. Thus, users can enter, retain, and retrieve organization specific risks. Users will be able to tailor risk reports as needed both onscreen and for export. Currently reports are in two standard formats exported to MS Word, MS Excel, CSV, and PDF. Embodiments of the system and method are adapted for specific industries such as medical devices, automotive and business investment. The risk levels for each individual risk are currently used to ascertain how well the risk has been addressed to date: also, they can be used to assist the User to solve the risk.

At any point, the User may opt to end system use. All User inputs are saved, locally or remotely, for future use and reference.

### EXAMPLES

### Example 1

Electronic device job management. In an electronic device, which includes, computer processors, mobile devices, personal data appliances, smartphones, etc., the disclosed method acting internally to the electronic device, the system operating on an external processor, or both the system and the method can be used to determine risks of performance of a module. In this case, the module is the electronic device that is being asked to perform a particular function. If in a computer processor, for example, a User is requesting that multiple functions be performed at once, the computer processor or other module can immediately run a self-diagnostic, using the present method, to determine whether risks of processor (or module) failure.

Similarly, a smartphone, mobile device or other module that receives a request for text communication, voice and/or video communication, internet use, photo sharing, conferencing and internal app usage (i.e., .wav files, .mp3, etc.) might fail due to a dearth of processing time required to execute all requests. The present system presents questions to the user to determine whether the requests should be honored or whether the system should propose offloading some of the requests to an external device due to the risk of failure of the mobile device. The User can disregard the risks and decide to continue with the requested actions or the user can acknowledge the determined risks and accept the system's offload suggestions. In such cases, the electronic devices can work much more efficiently.

### Example 2

Hardware and software development. The present system is applicable to project development, particularly, development of electronic devices such as computer processors, mobile devices, personal data appliances, smartphones, as well as software. In designing an electronic device or software, a “wish list” of device capabilities is considered attainable until, usually toward the end of the project, engineers cannot meet the wish list, despite considerable time, effort and money committed to the project.

### Example 3

Component interoperability. Often times, project developers want to combine a number of various existing products to create a new product or system. It sometimes cannot be determined at the inception of the project whether the various components of the project can be combined to create the new product or system. Such an endeavor must be undertaken without firm knowledge of whether the project will work. In such a case, the presently disclosed system and method can be used to determine potential roadblocks to achieving project success.

Combining various software modules, for example, is dependent upon programming language, processor capability, and other factors. Thus determining whether a single software environment can accept various programs in an attempt to create a larger system should be examined before the project is started. Similarly, in heavy mechanical industries, it must be determined whether it is possible to make certain large machines. The presently disclosed, system and method determines risks associated with undertaking particular designs.

The present system and method presents enough of a query to a User that the present system warns a User to potential road blocks, i.e., risks, and even provides suggestions for overcoming or avoiding the roadblocks. As such, the present device has non-traditional “computer aided design” (CAD) capabilities. The suggestions are generally based on past success and failures of similar programs. Suggestions are also based on capabilities of known technology. There are limits to known technologies for which the CAD features of the present system accounts.

Although the invention is illustrated and described herein with reference to specific embodiments, the invention is not intended to be limited to the details shown. Rather, various modifications may be made in the details within the scope and range of equivalents of the claims and without departing from the invention. Accordingly, it is intended that the appended claims cover all such variations as fall within the spirit and scope of the invention.

What is claimed:

1. A method for project risk assessment comprising:
collecting project identification information,
receiving responses to a single comprehensive query about the project,
using the responses to find specific characteristics of a coupled module for performing tasks related to the project, and
determining a risk level of the module performing the tasks based on the specific characteristics of the coupled module.

2. The method as recited in claim 1 wherein the single comprehensive survey is based on a set of known factors and is applicable to mutually exclusive projects.

3. The method as recited in claim 2 wherein the set of known factors comprise two hundred and eighteen mutually exclusive factors.

4. The method as recited in claim 1 wherein the tasks are at least one risk area selected from the group of risk areas consisting of technical, organizational, operational, external managerial and enterprise.

5. The method as recited in claim 4 further comprising producing a generic risk determination based on all of the areas.

6. The method as recited in claim 4 wherein all of the risk areas collectively comprise thirty-one risk categories and wherein all of the risk categories collectively comprise two hundred and eighteen individual risks.

7. The method as recited in claim 1 wherein less than all of the individual risks are considered when determining the risk level.

8. The method as recited in claim 4 further comprising producing a risk level for each of the risk areas.

9. The method as recited in claim 8 further comprising revising the risk level in response to a user request.

10. The method as recited in claim 1 wherein the specific characteristics of the coupled module are selected from the group consisting of a history of the coupled module, a bandwidth of the coupled module, available bandwidth of the coupled module, special resources of the coupled module, logistics, quality of resources, reuse of previously used resources, environment, regulatory considerations, geographic concerns and testing results.

11. The method as recited in claim 1 wherein the determining step is performed before the project is completed.

12. The method as recited in claim 11 wherein the determining step is performed before the project is begun.

13. The method as recited in claim 1 further comprising plotting a risk trend over time during project execution.

14. The method as recited in claim 13 further comprising modifying the determined risk based on the risk trend as the risk trend is plotted.
